(19) United States
(12) Patent Application Publication
(10) Pub. No.: US 2026/0330291 A1
(43) Pub. Date: Oct. 22, 2026

(54) DISTRIBUTIONAL PREFERENCE ALIGNMENT OF MACHINE LEARNING MODELS VIA OPTIMAL TRANSPORT

(71) Applicant: International Business Machines Corporation, Armonk, NY (US)

(72) Inventors: Youssef Mroueh, New york, NY (US); Brian Michael Belgodere, Fairfield, CT (US); Mattia Rigotti, Rueschlikon (CH); Apoorva Nitsure, Cupertino, CA (US); Mikhail Yurochkin, Cambridge, MA (US); Kristjan Herbert Greenewald, Belmont, MA (US); Jiri Navratil, Cortlandt Manor, NY (US); Jarret Ross, Wichita, KS (US); Igor Melnyk, White Plains, NY (US)

(73) Assignee: International Business Machines Corporation, Armonk, NY (US)

(21) Appl. No.: 19/181,840

(22) Filed: Apr. 17, 2025

(51) Int. Cl. G06N 20/00

(52) U.S. Cl. CPC G06N 20/00

(57) ABSTRACT

An embodiment includes responsive to a prompt received by a model input interface of a machine learning model, executing by the machine learning model outputting a current response. The embodiment includes determining by a reward component, based on the current response, a reference response and a preference data, a reward distribution of positive responses and a reward distribution of negative responses wherein the reference response is outputted by the machine learning model before training based on the prompt. The embodiment also includes issuing an optimizing instruction to an optimization interface on the machine learning model, execution of the optimizing instruction on the machine learning model causing alignment of the machine learning model with the preference data according to an alignment optimal transport solution based on the reward distribution of positive responses and the reward distribution of negative responses.

### BACKGROUND

The present invention relates generally to machine learning. More particularly, the present invention relates to a method, system, and computer program for Distributional Preference Alignment of Machine Learning Models Via Optimal Transport.

Maintaining control over artificial intelligence (AI) has become a popular area of research with the rise of generative AI, deep-learning models pre-trained on datasets the size of the internet to mimic the way humans communicate and create. Chatbots powered by one form of generative artificial intelligence (AI), machine learning models such as large language models (LLMs), have stunned the world with their ability to carry on open-ended conversations and solve complex tasks. LLMs are advanced artificial intelligence systems designed to understand, interpret, and generate human-like text. They are a type of deep learning model that have been trained on a wide variety of texts to understand how characters, words, and sentences function together. Deep learning involves the probabilistic analysis of unstructured data, which eventually enables the deep learning model to recognize distinctions between pieces of content without human intervention.

Alignment is the process of encoding human values and goals into machine learning models such as large language models to make them as helpful, safe, and reliable as possible. Through alignment, enterprises can tailor AI models to follow their business rules and policies. Alignment is meant to reduce these risks and ensure that AI assistants are as helpful, truthful, and transparent as possible. Alignment tries to resolve the mismatch between an LLM's mathematical training, and the soft skills we humans expect in a conversational partner. By ensuring that LLMs adhere to human preferences, values, ethics, and desired behaviors we can reduce the risk of generating harmful, biased, or inappropriate content.

### SUMMARY

The illustrative embodiments provide for Distributional Preference Alignment of Machine Learning Models Via Optimal Transport. An embodiment includes responsive to a prompt received by a model input interface of a machine learning model, executing by the machine learning model outputting a current response. The embodiment includes determining by a reward component, based on the current response, a reference response and a preference dataset, a reward distribution of positive responses and a reward distribution of negative responses wherein the reference response is outputted by the machine learning model before training based on the prompt. The embodiment also includes issuing an optimizing instruction to an optimization interface on the machine learning model, execution of the optimizing instruction on the machine learning model causing alignment of the machine learning model with the preference dataset according to an alignment optimal transport solution based on the reward distribution of positive responses and the reward distribution of negative responses.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a system diagram of distributional preference alignment of a machine learning model via optimal transport in an environment in accordance with an illustrative embodiment;

FIG. 3 depicts a diagram of a direct preference optimization technique for solving the machine learning model alignment problem in an environment in accordance with an illustrative embodiment;

FIG. 4 depicts a diagram of a first order stochastic dominance technique in an environment in accordance with an illustrative embodiment;

FIG. 5 depicts a diagram showing a reward distribution of positive responses exhibit a first-order stochastic dominance over the reward distribution of negative responses without a paired positive and negative response for each prompt in an environment in accordance with an illustrative embodiment;

FIG. 6 depicts a diagram showing a first-order stochastic dominance of positive to negative margin distribution of the model to align over the reference's margin distribution in accordance with an illustrative embodiment;

FIG. 7 depicts a diagram showing a determination of a preference dataset in an environment in accordance with an illustrative embodiment;

FIG. 8 depicts a diagram of first order stochastic dominance technique for machine learning model alignment in accordance with an illustrative embodiment;

FIG. 9 depicts a diagram of a convex relaxation technique for machine learning model alignment in accordance with an illustrative embodiment;

FIG. 10 depicts a diagram of a transporter problem and computational algorithm via sorting for machine learning model alignment in accordance with an illustrative embodiment;

FIG. 11 depicts a flow chart of machine learning model alignment in accordance with an illustrative embodiment; and

FIG. 12 depicts a diagram of quantile comparison of rewards of different alignment strategies and quantile comparison of margins of different alignment strategies in accordance with an illustrative embodiment.

### DETAILED DESCRIPTION

Large language models (LLMs) have seen increasing popularity in daily use, with their widespread adoption by many corporations as virtual assistants, chatbots, predictors, and many more. The growing influence of these technologies raises the need for safeguards and guardrails to ensure that the outputs from LLMs do not mislead or harm users. This is especially true for highly regulated domains such as healthcare, where misleading advice may influence users to commit malpractice unknowingly. Moreover, these models are typically trained on massive large-scale datasets, and if developed without proper governance, they can readily generate outputs that are not only inaccurate but potentially harmful. Therefore, it is crucial to establish safeguards to ensure their responsible use especially in heavily regulated industries, such as healthcare, law, and finance, that deal with critical decision-making.

General solutions to safeguard LLMs fall into two categories: (i) external models or filters to prevent harmful outputs and/or (ii) specific safety training in the fine-tuning phase. Currently, there is no way for recognizing advice in the context of safeguarding LLMs. Guardrails technologies aim to mitigate this risk by filtering LLMs'input/output text through various detectors. However, developing and maintaining robust detectors has many challenges, one of which is the difficulty in acquiring production-quality labeled data on real LLM outputs before deployment.

The following description provides examples of embodiments of the present disclosure, and variations and substitutions may be made in other embodiments. Several examples will now be provided to further clarify various aspects of the present disclosure.

Example 1: A computer-implemented method that comprises responsive to a prompt received by a model input interface of a machine learning model, executing by the machine learning model outputting a current response. The method further comprises determining by a reward component, based on the current response, a reference response and a preference dataset, a reward distribution of positive responses and a reward distribution of negative responses wherein the reference response is outputted by the machine learning model before training based on the prompt. The method further comprises issuing an optimizing instruction to an optimization interface on the machine learning model, execution of the optimizing instruction on the machine learning model causing alignment of the machine learning model with the preference dataset according to an alignment optimal transport solution based on the reward distribution of positive responses and the reward distribution of negative responses.

The above limitations advantageously enable distributional preference alignment of machine learning models. The limitations enable a machine learning model with alignment via optimal transport (AOT), which enables alignment by penalizing the violation of a stochastic dominance of the reward distribution of the positive samples on the reward distribution of the negative samples. AOT aligns models on unpaired preference data by making the reward distribution of the positive samples stochastically dominant in the first order on the distribution of negative samples. The above limitations advantageously enable improvements to computer resources such as computer processing since the computations are not at a sample level.

As used herein, the term “machine learning model” refers to any computer model that can be used to facilitate one or more machine learning tasks, wherein the computer model can simulate a number of interconnected processing units that can resemble abstract versions of neurons. For example, the processing units can be arranged in a plurality of layers (e.g., one or more input layers, one or more hidden layers, and/or one or more output layers) connected with by varying connection strengths (e.g., which can be commonly referred to within the art as “weights”). Machine learning models can learn through training, where data with known outcomes is inputted into the computer model, outputs regarding the data are compared to the known outcomes, and/or the weights of the computer model are autonomously adjusted based on the comparison to replicate the known outcomes.

The term “reward” as used herein, and without implying any limitation thereto, may refer to a score to indicate whether a machine learning model response is desirable or not desirable, positive or negative, and/or chosen or rejected.

The term “distribution” as used herein, and without implying any limitation thereto, may refer to a mathematical function that gives the probabilities of occurrence of possible outcomes.

The term “alignment” as used herein, and without implying any limitation thereto, may refer to a process of ensuring that machine learning models adhere to human preferences, values, ethics, and desired behaviors we can reduce the risk of generating harmful, biased, or inappropriate content.

The term “optimizing” as used herein, and without implying any limitation thereto, may refer to a process of iteratively adjusting machine learning model parameters to minimize (or maximize) a specific objective function, aiming to improve model accuracy and performance.

Example 2: The limitations of Example 1, where the reward distribution of positive responses exhibits a first-order stochastic dominance over the reward distribution of negative responses.

The above limitations advantageously enable a machine learning model with alignment via optimal transport (AOT), which enables alignment by penalizing the violation of a stochastic dominance of the reward distribution of the positive samples on the reward distribution of the negative samples. Additionally, the limitations realize the benefits described with respect to Example 1.

Example 3: The limitations of Example 2, further comprising applying a convex relaxation of the stochastic dominance condition to enable the optimal transport solution.

The above limitations advantageously enable optimizing relaxed first order stochastic dominance (FSD) as an inner one-dimensional optimal transport problem with smooth and convex cost to enable ease of optimization. This also enables more efficient use of processing and other computer resources since less computations are needed. Additionally, the limitations realize the benefits described with respect to Examples 1-2.

Example 4: The limitations of Example 1, further comprising applying sorting of the reward distribution of positive responses and the reward distribution of negative responses to penalize a violation of stochastic dominance.

The above limitations advantageously enable turning a constraint into an objective to further enable computation of the alignment. Additionally, the limitations realize the benefits described with respect to Examples 1-3.

Example 5: The limitations of Example 1, where the preference data is unpaired, and a log probability ratio of a chosen reward exhibits a first-order stochastic dominance over a log probability ratio of a rejected reward.

The above limitations advantageously enable machine learning model alignment using unpaired data. This advantage allows for alignment using unpaired preference data, enhancing flexibility and reducing dependence on annotated datasets. This also reduces computer resources since computations are performed on reduced datasets. Additionally, the limitations realize the benefits described with respect to Examples 1-4.

Example 6: The limitations of Example 1, where the preference data is paired, and a log probability ratio of positive and negative responses of a policy exhibits a first-order stochastic dominance over a log probability ratio of positive and negative responses of a reference policy.

The above limitations advantageously enable machine learning model alignment using paired data. Additionally, the limitations realize the benefits described with respect to Examples 1-5.

Example 7: The limitations of Example 1, where a first-order stochastic dominance is cast from a pointwise constraint to a distributional constraint.

The above limitations advantageously enable machine learning model alignment to be performed based on the distribution of responses instead of pointwise basis. Additionally, the limitations realize the benefits described with respect to Examples 1-6.

Example 8: A computer program product comprising one or more computer readable storage media, and program instructions collectively stored on the one or more computer readable storage media, the program instructions executable by a processor to cause the processor to perform the method according to any of Examples 1-7. The computer program product of Example 6 realizes the benefits described with respect to Examples 1-7. The computer program product of Example 6 can advantageously be implemented into a variety of computer program products.

Example 9: A computer system comprising a processor and one or more computer readable storage media, and program instructions collectively stored on the one or more computer readable storage media, the program instructions executable by the processor to cause the processor to perform the method according to any of Examples 1-7. The computer system of Example 9 realizes the benefits described with respect to Examples 1-7. The computer system of Example 9 can advantageously be implemented into a variety of computer devices.

Example 10: A computer-implemented method that comprises responsive to a prompt received by a model input interface of a machine learning model, executing by the machine learning model outputting a current response. The method further comprises determining by a reward component, based on the current response, a reference response and preference data, a reward distribution of positive responses and a reward distribution of negative responses wherein the reference response is outputted by the machine learning model before training based on the prompt. The method further comprises issuing an optimizing instruction to an optimization interface on the machine learning model, execution of the optimizing instruction on the machine learning model causing alignment of the machine learning model with the preference data according to an alignment optimal transport solution based on the reward distribution of positive responses and the reward distribution of negative responses. The method further comprises wherein the reward distribution of positive responses exhibits a first-order stochastic dominance over the reward distribution of negative responses. The method further comprises applying a convex relaxation of the stochastic dominance condition to enable the optimal transport solution. The method further comprises applying sorting of the reward distribution of positive responses and the reward distribution of negative responses to penalize a violation of stochastic dominance. The above limitations realize the technical benefits described with respect to Examples 1-7.

Aspects of the present disclosure can be implemented in a variety of technical use cases. The following use cases are merely exemplary and are not intended to limit the scope of the disclosure.

In an example use case, a large language model (LLM) responds to a prompt comprising medical advice. The reward component of the system, based on the current response, a reference response and preference data, determines a reward distribution of positive responses and a reward distribution of negative responses wherein the reference response is outputted by the LLM before training based on the prompt. The preference data comprises of a dataset that consists of a prompt and a positive response and a separate dataset that consists of a prompt and a negative response. A positive response ensures that the LLM adhere to human preferences, values, ethics, and desired behaviors we can reduce the risk of generating harmful, biased, or inappropriate content. The system issues an optimizing instruction to an optimization interface on the machine learning model, execution of the optimizing instruction on the machine learning model causing alignment of the LLM with the preference data according to an alignment optimal transport solution based on the reward distribution of positive responses and the reward distribution of negative responses.

The present disclosure provides for a method, a machine-readable medium, and a system for Distributional Preference Alignment of Machine Learning Models Via Optimal Transport.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

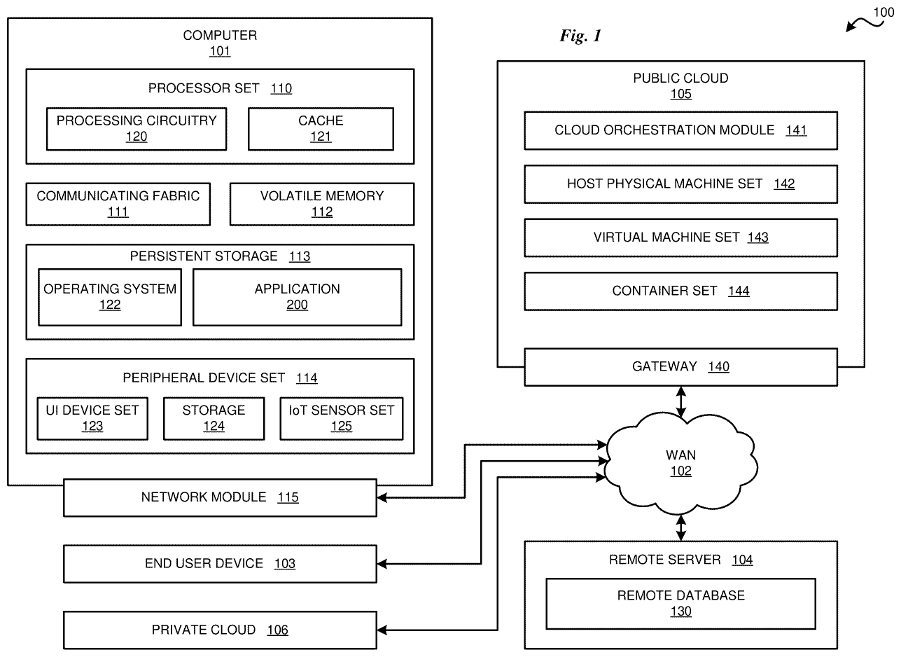

With reference to FIG. 1, this figure depicts a block diagram of a computing environment 100. Data center environment 100 contains an example of an environment for the execution of at least some of the computer code involved in performing the inventive methods, such as an Application 200 that provides Distributional Preference Alignment of Machine Learning Models Via Optimal Transport. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

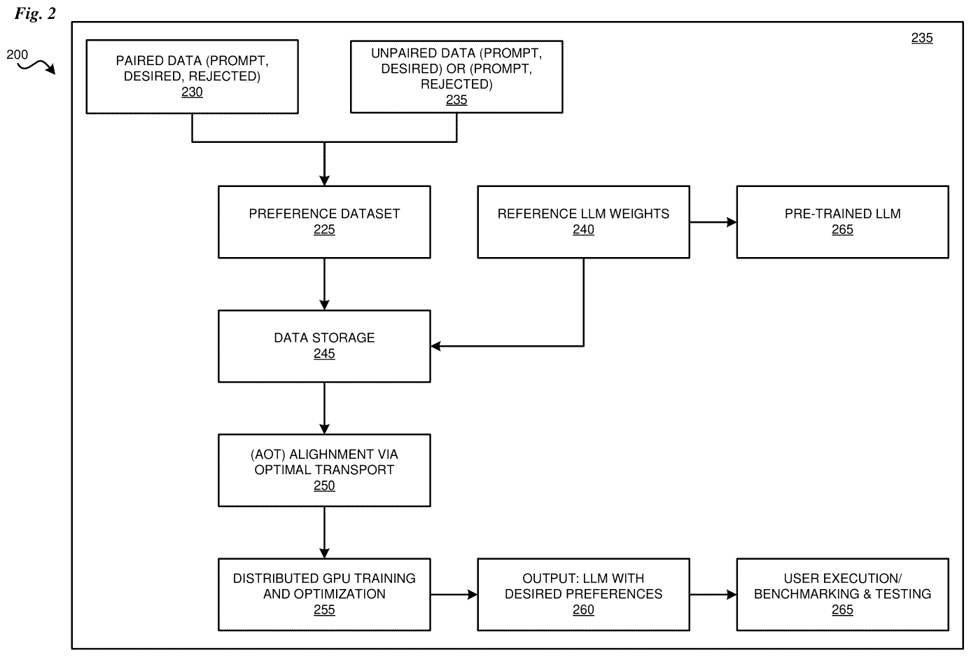

FIG. 2 depicts a system diagram of distributional preference alignment of a machine learning model via optimal transport in an environment in accordance with an illustrative embodiment. In a particular embodiment, the components of the diagram 200 show aspects of the Application 200 of FIG. 1.

In the illustrated embodiment, the system may comprise a machine learning model such as a large language model (LLM) 265, a data storage or data store 245, a general processing unit (GPU), and a central processing unit (CPU). The LLM 265 may comprise a neural network with an encoder-decoder architecture accepting input feature vectors to the machine learning model to perform predictions. The LLM 265 may further comprise a model input interface, an output interface, and an optimizing interface. GPU due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models.

A physical data storage device is the underlying technology behind a data store 245. The data store may comprise formats such as files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

In some embodiments, the data store stores a persistent attribute of a credential. Database persistence is the process of storing data in a way that allows it to be retrieved later, even after the application that created it has closed. This ensures that data remains accessible, reliable, and intact. Data is written to non-volatile storage, which can retain information long-term. Non-volatile storage can include hard disk drives (HDDs), cloud storage, or other storage devices. Persistent data can be accessed and updated across multiple transactions.

In the illustrated embodiment, a data store 245 stores a preference dataset 225 comprising preference data such as a paired dataset response 230, for example, a triplet comprising a prompt, a desired or chosen response and a rejected response. The preference dataset 225 may also comprise of an unpaired dataset response 235 such as a prompt and a chosen response or a prompt and a rejected response. In some embodiments, a pre-trained machine learning model 265, such as an LLM, is prompted with a prompt through the LLM model input interface to produce a preference dataset 225. The responses in of the preference dataset 225 are then presented to human labelers who express preferences for one answer, denoted as either the desired or chosen, or rejected.

In embodiments, a data store 245 stores a reference response. For example, the reference response is a response to a prompt from a pre-trained LLM 265, with reference LLM weights 240 and parameters, such as the LLM used to generate the preference dataset, prior to optimization. An alignment via optimal transport component 250 uses a central processing unit (CPU) interfacing with the LLM and the datastore to perform an alignment via optimal transport. For example, a reward component determines based on the current response, a reference response and a preference dataset, a reward distribution of positive responses and a reward distribution of negative responses. In such examples, the current response is a response from the LLM that is currently being optimized responsive to a prompt received by the LLM model input interface.

A distributed GPU training and optimization 255 receives data from the alignment via optimal transport component 250 to train and optimize the LLM so that the LLM aligns with the preference dataset to output a LLM with desired preferences 260. For example, an optimizing instruction is sent to an optimization interface on the LLM, execution of the optimizing instruction on the LLM causes alignment of the LLM with the preference dataset according to an alignment optimal transport component based on the reward distribution of positive responses and the reward distribution of negative responses. User execution, benchmarking or testing 265 may be performed on the output.

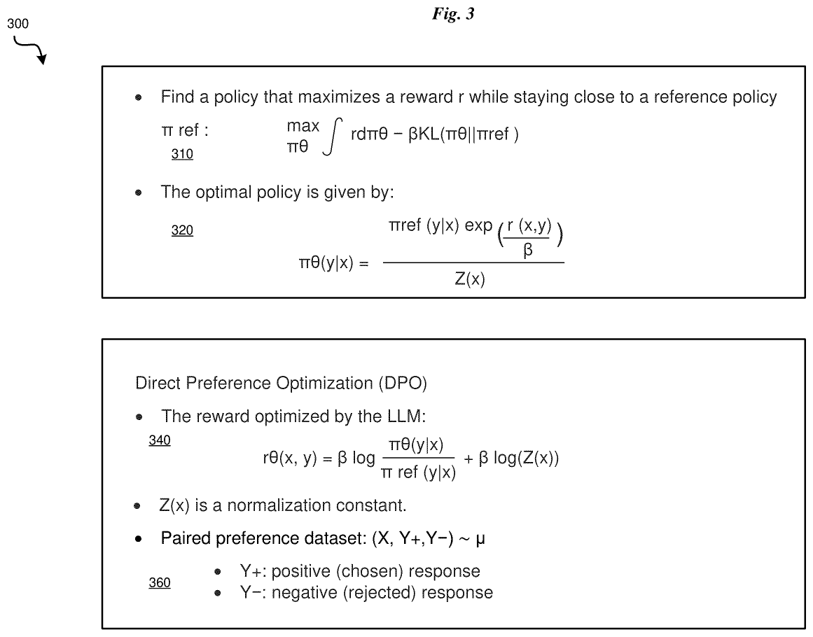

FIG. 3 depicts a diagram of a direct preference optimization technique for solving the machine learning model alignment problem in an environment in accordance with an illustrative embodiment. In a particular embodiment, the components of the diagram 300 show aspects of the Application 200 of FIG. 1.

In the illustrated embodiment, the algorithm 310 depicts an alignment problem as solving using a known (reward maximization with a KL-divergence constraint) technique to find a policy that maximizes a reward r, for a policy to be optimized π_{θ} while staying close to a reference policy π_{ref}, where π_{ref} is a policy (or response) of the machine learning model to a prompt. The variable d is a dataset, and β is a parameter controlling the deviation from the base reference policy π_{ref}. The optimal policy π_{θ} is given by algorithm 320.

A known technique, the direct preference optimization (DPO) technique, is depicted by 340. This technique works in the paired setting 360 focused on improving the reward of chosen sentences over rejected sentences on a per-sample or pointwise basis. This procedure does not lead to a preference on a distributional level of the chosen marginal on the rejected marginal. In probabilistic terms, we would like to induce stochastic dominance of the reward of chosen sentences on the reward of rejected ones.

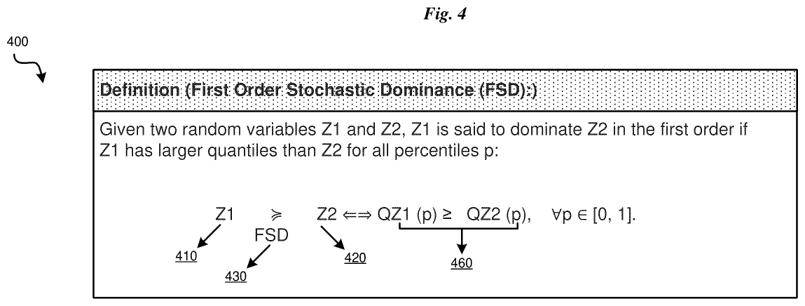

FIG. 4 depicts a diagram of a first order stochastic dominance technique in an environment in accordance with an illustrative embodiment. In a particular embodiment, the components of the diagram 400 show aspects of the Application 200 of FIG. 1.

In the illustrated embodiment, first order stochastic dominance (FSD,) means given two random variables Z1 (410) and Z2 (420), Z1 is said to (440) dominate Z2 in the first order 430) if Z1 has larger quantiles than Z2 (460) for all percentiles p.

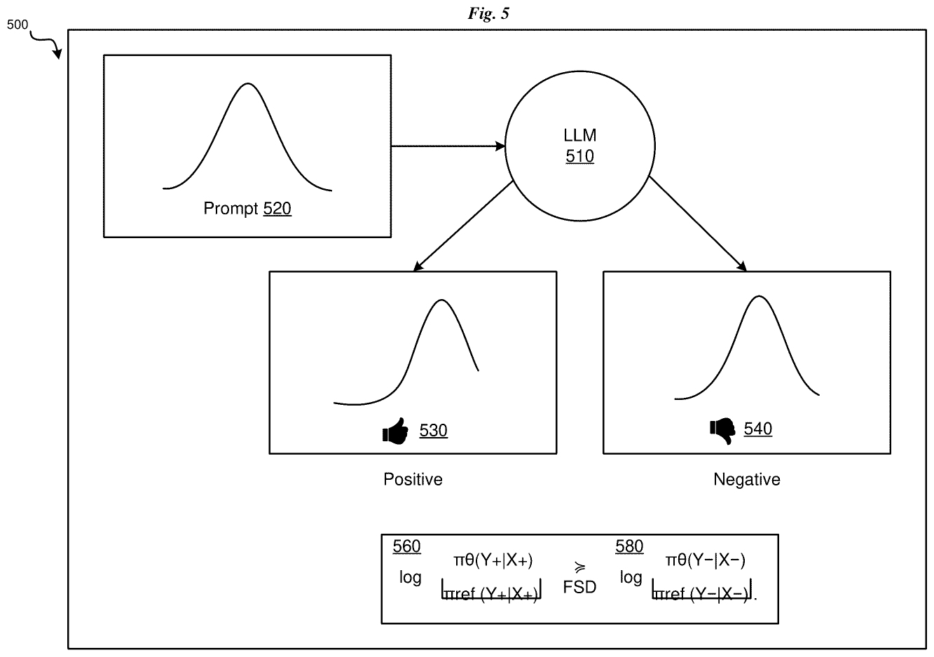

FIG. 5 depicts a diagram showing a reward distribution of positive responses exhibit a first-order stochastic dominance over the reward distribution of negative responses without a paired positive and negative response for each prompt in an environment in accordance with an illustrative embodiment. In a particular embodiment, the components of the diagram 500 show aspects of the Application 200 of FIG. 1.

In the illustrated embodiment, a LLM 510 receives a prompt 520. In response, based on the current response of the LLM 510, a reference response from a pre-trained LLM, and a preference data, a reward component determines a reward distribution of positive responses 530, shown represented by a histogram, and a reward distribution of negative responses 540, also shown depicted by a histogram. For example, there is no access to triplets of prompts and positive/negative responses (x, y+, y−). However, there is separate access to μ+∈P(X×Y), a distribution of positive prompt/response pairs (X+, Y+) to be rewarded, and μ−∈P(X×Y), a distribution of negative samples (X−, Y−) to be associated with a low reward. Alignment of the LLM results in a policy π_{θ} of the LLM to be optimized for alignment 560 that prefers distributionally μ+ over μ− with respect to a reference policy π_{ref} 580, without a paired positive and negative answer for each prompt.

Although a LLM is depicted, the described alignment technique applies to diverse data modalities beyond language, including visual, auditory, and other data types with corresponding reward distributions, thereby supporting multimodal alignment applications.

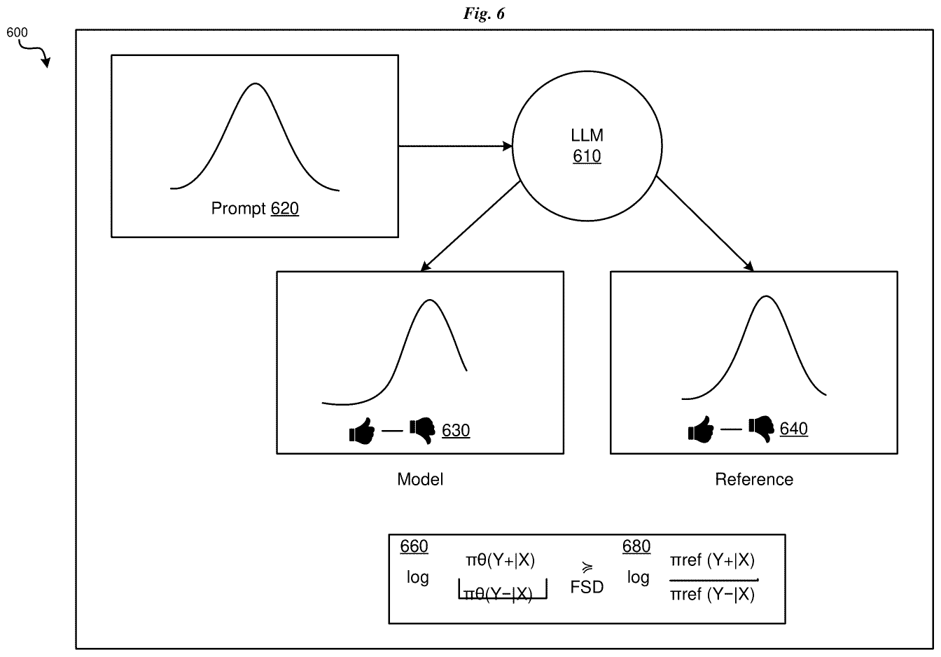

FIG. 6 depicts a diagram depicts a diagram showing a first-order stochastic dominance of positive to negative margin distribution of the model to align over the reference's margin distribution in an environment in accordance with an illustrative embodiment. In a particular embodiment, the components of the diagram 600 show aspects of the Application 200 of FIG. 1.

In the illustrated embodiment, a LLM 610 receives a prompt 620. In response, based on the current response of the LLM 630, a reference response from a pre-trained LLM 640, and a preference data, a reward component determines a reward distribution of positive responses 630, shown represented by a histogram, and a reward distribution of negative responses 640, also shown depicted by a histogram. Alignment of the LLM results in a policy π_{θ} 660 that distributionally dominates π_{ref} 680 in terms of log probability ratio of positive and negative responses, with a paired positive and negative answer for each prompt.

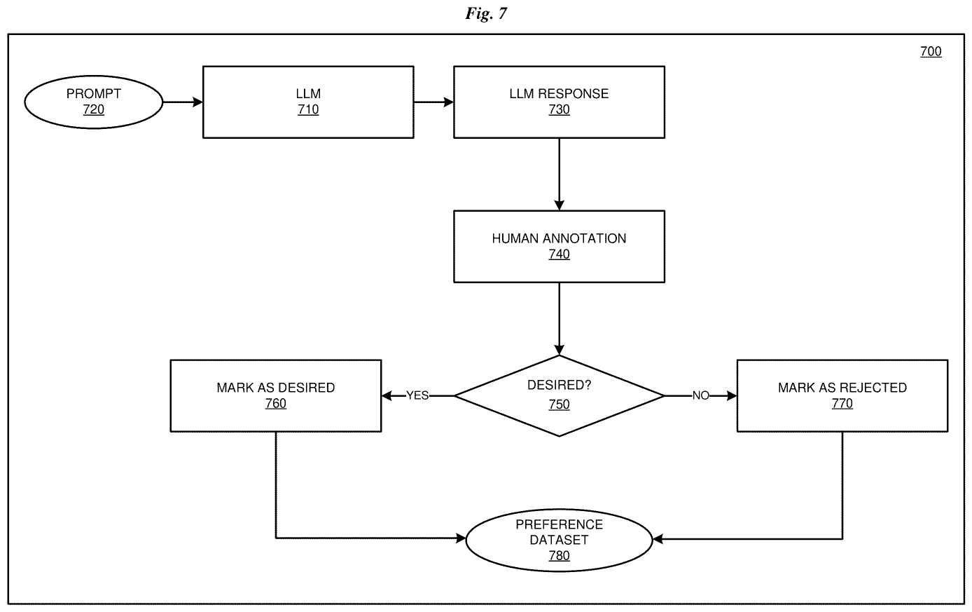

FIG. 7 depicts a diagram showing a determination of a preference dataset in an environment in accordance with an illustrative embodiment. In a particular embodiment, the components of the diagram 700 show aspects of the Application 200 of FIG. 1.

In the illustrated embodiment, a LLM 710 receives a prompt 720, and outputs a LLM response 730. Human annotation 740 is performed on the response where the human decides 750 whether to mark the response as desired 760 or mark as rejected 770. For example, the response may be marked as true/false, a percentage, a flag or equivalent. The decision is stored on a per prompt basis in a preference dataset 780 such as a set of a triplet of a prompt and a positive and/or negative response.

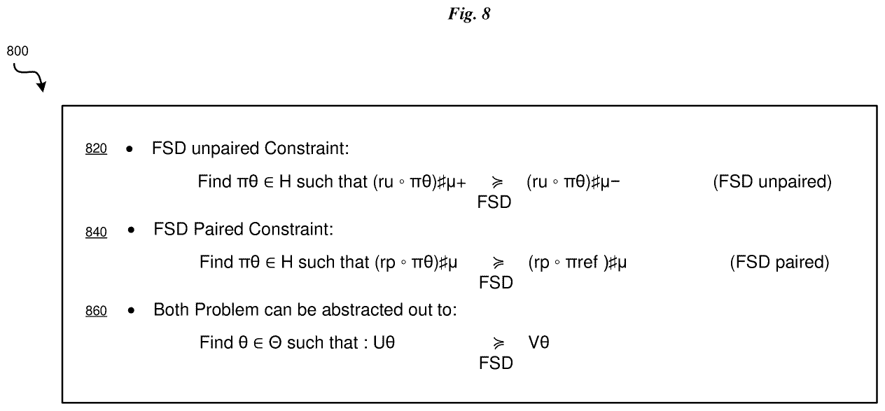

FIG. 8 depicts a diagram of first order stochastic dominance technique for machine learning model alignment in accordance with an illustrative embodiment. In a particular embodiment, the components of the diagram 800 show aspects of the Application 200 of FIG. 1.

In the illustrated embodiment, algorithm 820 depicts the first order stochastic dominance (FSD) technique for an unpaired preference dataset where rᵤ is the unpaired reward defined at 340. Algorithm 840 depicts the first order stochastic dominance (FSD) technique for an unpaired preference dataset where rₚ is the unpaired reward. Both algorithms 820 and 840 may be abstracted out to algorithm 860.

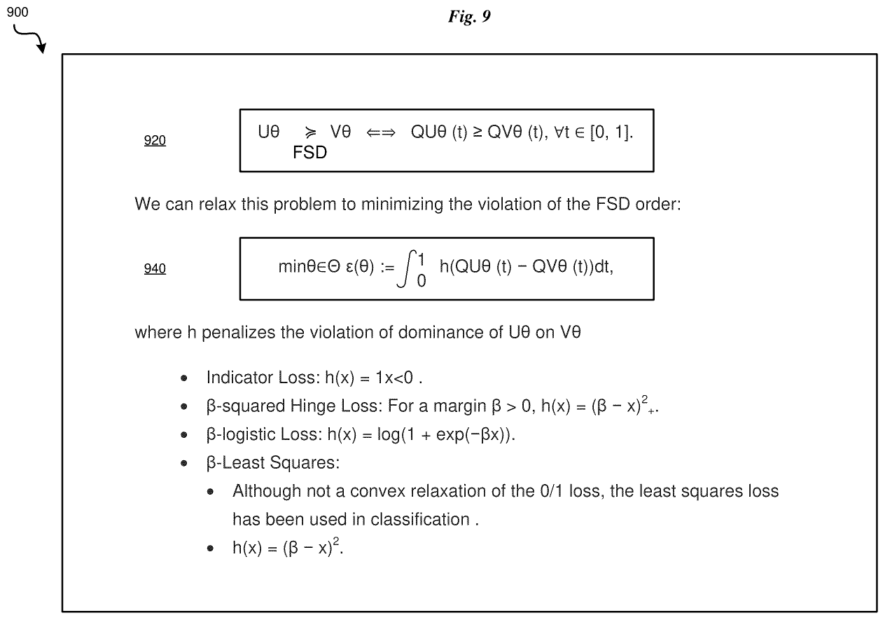

FIG. 9 depicts a diagram of a convex relaxation technique for machine learning model alignment in accordance with an illustrative embodiment. In a particular embodiment, the components of the diagram 900 show aspects of the Application 200 of FIG. 1.

In the illustrated embodiment, algorithm 920 describes the abstraction of 860 such that all the quantiles Q for positive should be greater than the quantiles for the negative, where U is the positive and V is the negative. Algorithm 920 may be relaxed to minimizing and/or penalizing the violation of the FSD order as depicted in 940, thus turning a constraint into an objective.

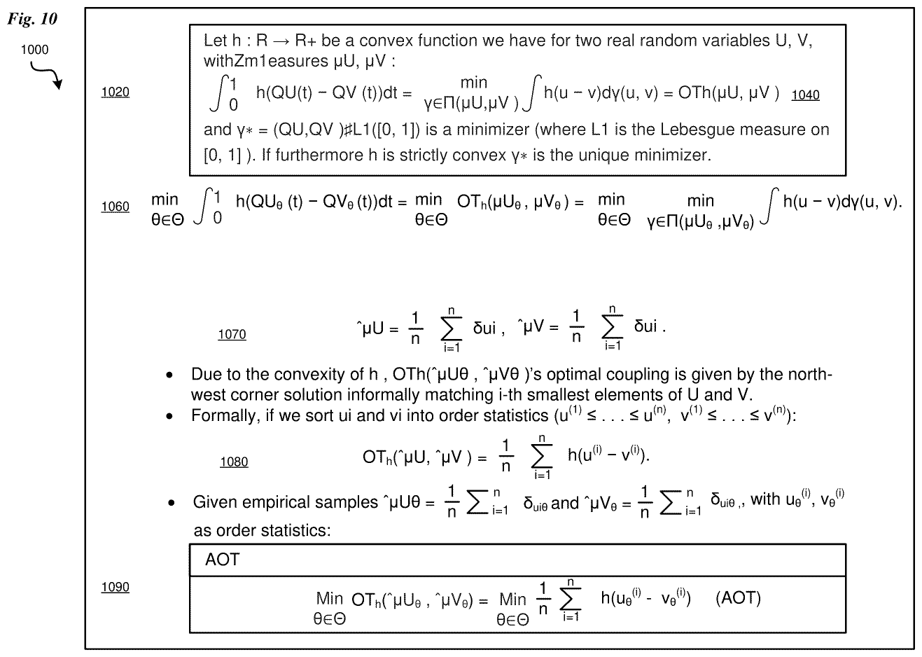

FIG. 10 depicts a diagram of a transporter problem and computational algorithm via sorting for machine learning model alignment in accordance with an illustrative embodiment. In a particular embodiment, the components of the diagram 1000 show aspects of the Application 200 of FIG. 1.

In the illustrated embodiment, the function h as depicted in 940, is a cost of an optimal transporter problem 1040, that penalizes the violation of the desired stochastic dominance of positive on negative. Optimal transport finds a joint distribution between the positive and the negative that minimizes this cost 1020. For example, the original problem is a difficult quantity to minimize because the quantiles need to be determined. But if written as an optimal transporter problem, it will become easier to optimize. Technique 1060 depicts optimizing relaxed FSD as an inner one-dimensional optimal transport problem with smooth and convex cost. Technique 1070 depicts taking all the positive behaviors, \muᵤ, the negative behaviors \muᵥ and technique 1080 depicts sorting the positive from the smallest to the highest and sort the negative behavior from the smallest to the highest. Technique 1090 is the optimized alignment optimal transport solution (AOT) where the values of the positive reward u⁽ⁱ⁾_{θ} and the values of the negative reward v⁽ⁱ⁾_{θ} are sorted. And then impose that the minimum of positive bigger than the minimum of negative, the median of positive bigger than the median of negative and so on until the maximum of positive is bigger than the maximum of negative.

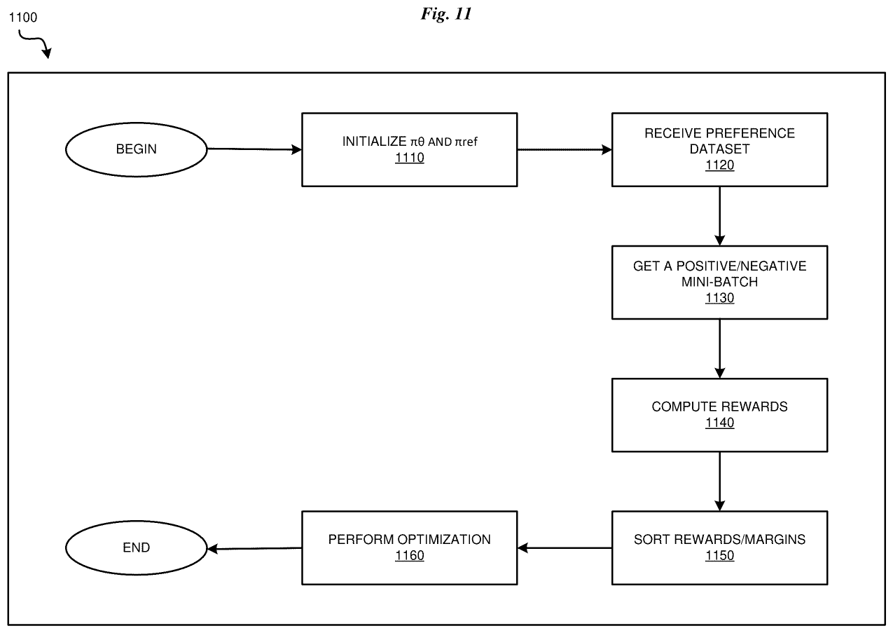

FIG. 11 depicts a flow chart of machine learning model alignment in accordance with an illustrative embodiment. In a particular embodiment, the components of the diagram 1100 show aspects of the Application 200 of FIG. 1.

In the illustrated embodiment, the process begins at step 1110 where π_{θ} and π_{ref} are initialized and input into the system. For example, π_{θ} is the current response or policy outputted by a machine learning model to be optimized based on a prompt received by a model input interface of the machine learning model and π_{ref} is the reference response or policy outputted by the machine learning model before training/optimization based on the prompt. In some embodiments, at an initial stage, both π_{θ} and π_{ref} may be initialized to the output of the pre-trained and unoptimized model based on the prompt.

At step 1120, the system receives a preference data. For example, the preference dataset may be human annotated or may be generated by a LLM that is trained to reward positive responses and mark with a low reward for negative responses. The preference dataset is stored in the data store.

At step 1130, the system gets and determines a positive/negative mini batch. This step matches the entries in the preference data with the entries in the current response and reference response.

At step 1140, the compute rewards step is performed. For example, the system uses the CPU and the data store to compute the rewards for unpaired data, using the technique as depicted in 560 and 580, and computing the margins for the paired data, using the technique as depicted in 660 and 680.

At step 1150, the system sorts the rewards/margins. For instance, if the data is unpaired, the rewards are sorted. If the data is paired, the margins are sorted. Sorting may be implemented on the CPU, GPU or in combination. As an example, the rewards/margins are modified into a tensor array and the sorting is performed along the columns or rows.

At step 1160, the system performs optimization for machine learning model alignment by issuing an optimizing instruction to an optimization interface on the machine learning model. In some embodiments, execution of the optimizing instruction on the machine learning model determines the AOT logistic loss as depicted, for example, in 940. In embodiments, gradient descent, an iterative optimization algorithm is performed by the system to minimize the loss function, which quantifies the difference between a model's predictions and the actual values, by adjusting the model's parameters (weights and biases) in the direction of the steepest descent of the loss function. In such examples, the optimization interface of the machine learning model interfaces with a CPU and/or a GPU, as multi-thread routines for multi-core the CPU, and as highly parallel kernels executed on the GPU. The weights, biases and parameters in the data store may be used as inputs for the optimization. One known technique is Adaptive Moment Estimation (ADAM).

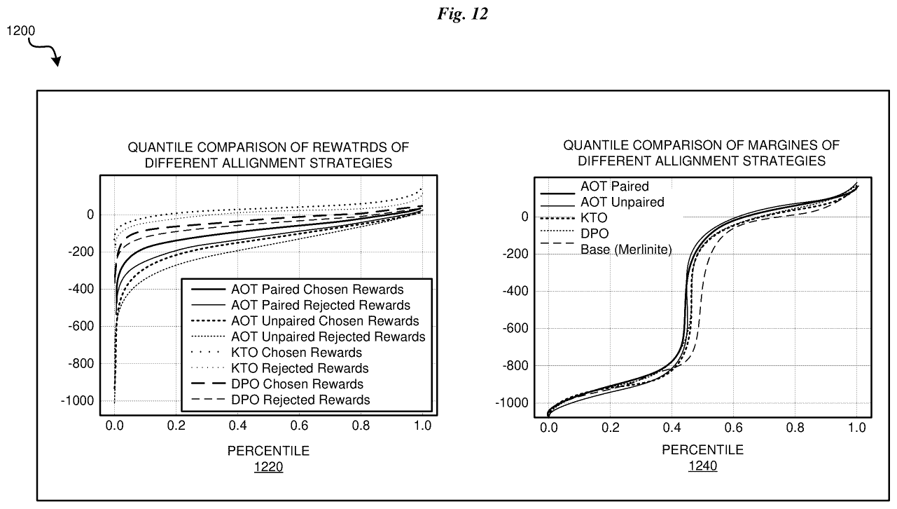

FIG. 12 depicts a diagram of quantile comparison of rewards of different alignment strategies and quantile comparison of margins of different alignment strategies in accordance with an illustrative embodiment. In a particular embodiment, the components of the diagram 1200 show aspects of the Application 200 of FIG. 1.

In the illustrated embodiment, the plot 1220 depicts the stochastic dominance of reward of chosen or rejected AOT achieves a larger margin between the quantile plots of chosen and rejected rewards than for alternate techniques. The plot 1240 depicts AOT's policy chosen to rejected log-likelihood ratio dominates that ratio for the base model measured against alternative strategies.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
responsive to a prompt received by a model input interface of a machine learning model, executing by the machine learning model outputting a current response;
determining by a reward component, based on the current response, a reference response and preference data, a reward distribution of positive responses and a reward distribution of negative responses wherein the reference response is outputted by the machine learning model before training based on the prompt; and
issuing an optimizing instruction to an optimization interface on the machine learning model, execution of the optimizing instruction on the machine learning model causing alignment of the machine learning model with the preference data according to an alignment optimal transport solution based on the reward distribution of positive responses and the reward distribution of negative responses.

2. The computer-implemented method of claim 1, wherein the reward distribution of positive responses exhibits a first-order stochastic dominance over the reward distribution of negative responses.

3. The computer-implemented method of claim 2, further comprising applying a convex relaxation of the stochastic dominance condition to enable the alignment optimal transport solution.

4. The computer-implemented method of claim 1, further comprising applying sorting of the reward distribution of positive responses and the reward distribution of negative responses to penalize a violation of stochastic dominance.

5. The computer-implemented method of claim 1, wherein the preference data is unpaired, and a log probability ratio of a chosen reward exhibits a first-order stochastic dominance over a log probability ratio of a rejected reward.

6. The computer-implemented method of claim 1, wherein the preference data is paired, and a log probability ratio of positive and negative responses of a policy exhibits a first-order stochastic dominance over a log probability ratio of positive and negative responses of a reference policy.

7. The computer-implemented method of claim 1, wherein a first-order stochastic dominance is cast from a pointwise constraint to a distributional constraint.

8. A computer program product comprising one or more computer readable storage media, and program instructions collectively stored on the one or more computer readable storage media, the program instructions executable by a processor to cause the processor to perform operations comprising:
responsive to a prompt received by a model input interface of a machine learning model, executing by the machine learning model outputting a current response;
determining by a reward component, based on the current response, a reference response and preference data, a reward distribution of positive responses and a reward distribution of negative responses wherein the reference response is outputted by the machine learning model before training based on the prompt; and
issuing an optimizing instruction to an optimization interface on the machine learning model, execution of the optimizing instruction on the machine learning model causing alignment of the machine learning model with the preference data according to an alignment optimal transport solution based on the reward distribution of positive responses and the reward distribution of negative responses.

9. The computer program product of claim 8, wherein the reward distribution of positive responses exhibits a first-order stochastic dominance over the reward distribution of negative responses.

10. The computer program product of claim 9, further comprising applying a convex relaxation of the stochastic dominance condition to enable the alignment optimal transport solution.

11. The computer program product of claim 8, further comprising applying sorting of the reward distribution of positive responses and the reward distribution of negative responses to penalize a violation of stochastic dominance.

12. The computer program product of claim 8, wherein the preference data is unpaired, and a log probability ratio of a chosen reward exhibits a first-order stochastic dominance over a log probability ratio of a rejected reward.

13. The computer program product of claim 8, wherein the preference data is paired, and a log probability ratio of positive and negative responses of a policy exhibits a first-order stochastic dominance over a log probability ratio of positive and negative responses of a reference policy.

14. The computer program product of claim 8, wherein a first-order stochastic dominance is cast from a pointwise constraint to a distributional constraint.

15. A computer system comprising a processor and one or more computer readable storage media, and program instructions collectively stored on the one or more computer readable storage media, the program instructions executable by the processor to cause the processor to perform operations comprising:
responsive to a prompt received by a model input interface of a machine learning model, executing by the machine learning model outputting a current response;
determining by a reward component, based on the current response, a reference response and a preference data, a reward distribution of positive responses and a reward distribution of negative responses wherein the reference response is outputted by the machine learning model before training based on the prompt; and
issuing an optimizing instruction to an optimization interface on the machine learning model, execution of the optimizing instruction on the machine learning model causing alignment of the machine learning model with the preference data according to an alignment optimal transport solution based on the reward distribution of positive responses and the reward distribution of negative responses.

16. The computer system of claim 15, wherein the reward distribution of positive responses exhibits a first-order stochastic dominance over the reward distribution of negative responses.

17. The computer system of claim 16, further comprising applying a convex relaxation of the stochastic dominance condition to enable the alignment optimal transport solution.

18. The computer system of claim 15, further comprising applying sorting of the reward distribution of positive responses and the reward distribution of negative responses to penalize a violation of stochastic dominance.

19. The computer system of claim 15, wherein the preference data is unpaired, and a log probability ratio of a chosen reward exhibits a first-order stochastic dominance over a log probability ratio of a rejected reward.

20. The computer system of claim 15, wherein the preference data is paired, and a log probability ratio of positive and negative responses of a policy exhibits a first-order stochastic dominance over a log probability ratio of positive and negative responses of a reference policy.
